(19) United States
(12) Patent Application Publication
(10) Pub. No.: US 2013/0018905 A1
(43) Pub. Date: Jan. 17, 2013

(54) METHOD AND RECORDING MACHINE FOR RECORDING HEALTH-RELATED INFORMATION

(71) Applicant: Karl Tesmer, Viganello (CH)

(72) Inventor: Karl Tesmer, Viganello (CH)

(73) Assignee: NORMAMED S.A., Luxemburg (LU)

(21) Appl. No.: 13/637,308

(22) PCT Filed: Mar. 25, 2010
(86) PCT No.: PCT/EP10/01882

§ 371 Date: Sep. 25, 2012

(51) Int. Cl. G06F 17/30

(52) U.S. Cl. 707/756; 707/736; 707/E17.009

(57) ABSTRACT

The invention relates to a method (E) for recording health-related information (GI) about internal organs and/or a metabolism of a person to be examined. Based on input questions, cartographic features (M, 13a, 13b, 13c, 13d, 13e) in the mouth/throat/cheek area (3) of the person to be examined are acquired via an interface (19) with an acquisition machine (21) and this information is made available in the form of machine-readable data (MD) for a subsequent conversion to health-related information (GI) about the internal organs and/or the metabolism. Furthermore, the invention relates to an acquisition machine (21) which can be used for this purpose.

The present invention relates to a method for recording health-related information about internal organs and/or a metabolism of a person to be examined. It also relates to a recording machine for the same purpose.

In recording health related information, a number of automatic aids may be relied on today. For example, a dentist will often document a patient's dental status in a so-called dental chart, which today is usually stored on a computer system in addition to being stored in a paper patient file.

Computer systems today not only allow graphical recording and display of health-related information but also offer the possibility of further processing of the input data. Such a system is described in WO 2004/001665 A2, for example, which also discloses that it is possible to enter information into such computer systems over the Internet.

The quality of information provided by computer systems permitting inferences as to disease conditions on the basis of health-related information recorded previously depends to a significant extent on the data input. Especially in the case of remote queries over the Internet, but also in the case of on-site entries by a handler, i.e., a treatment person, the limits of the systems are encountered repeatedly because a person must enter information that allows the clearest possible specific conclusions about disease conditions. These statements must then be convertible into machine-processable systems, but that is difficult in many cases.

The object of the present invention is to record additional health-related information in such systems in the simplest way possible, which can be expected to create added informational value for interpreting the health status of a person to be examined.

This object is achieved by a method according to claim 1 and by the recording machine according to claim 12.

Accordingly, as part of a method of the type defined in the introduction, cartographic features in the mouth/throat/cheek area of the person to be examined are recorded on the basis of input questions via an interface using a recording machine and is supplied in the form of machine-readable data for a subsequent conversion into health-related information about the internal organs and/or the metabolism.

This data acquisition process preferably involves an interactive process, in which the person to be examined and/or a second person assisting the former receives the input questions presented to him/her and then makes entries, whereupon additional questions are presented—optionally taking into account entries made previously.

The input questions are understood to include all questions or instructions suitable for instructing a user to provide information in a targeted manner. For example, they may be in the form of a given catalog of questions but may also be in the form of individual questions or even operating instructions or in mixed forms of various question categories and/or instruction categories.

A computer and/or a computer system is preferably used as the recording machine, but other types of automatic units into which information can be entered and which then supply this information automatically in the form of machine-readable data, for example, an image analysis unit, may also be used. Providing the information may, but need not necessarily, involve converting the information into machine-readable data. However, data that is already in a machine-readable form, e.g., in the form of numerical codes, may also be input, in which case, the recording machine only stores and optionally processes and/or systematizes the numerical codes and supplies them for further processing. The machine-readable data especially preferably comprises data supplied in the form of a computer-readable code, in particular in the form of a hexadecimal code and/or a binary code and/or an ASCII code and/or a Unicode.

Information about internal organs and/or the patient's metabolism relates to the condition of these organs and/or the metabolism, so that with adequate technical knowledge, conclusions can be drawn about diseases, abnormalities or even harmless health situations. The statement about the condition of an organ comprises in particular one of the following statements:
whether the organ fulfills its intended function completely, partially or not at all and/or
whether it has anything unusual or certain unusual aspects with regard to its size and/or properties and/or
whether there is any disease in the organ or a certain disease.

The situation is similar for the statement about the metabolism: the important issue here is in particular whether starting materials are converted into end products and processes as intended completely, partially or not at all within the context of the metabolism.

This method relates to the acquisition of health-related information about internal organs and/or the metabolism. Internal organs are preferably understood to refer to the internal organs of the abdominal and/or thoracic cavity and/or the brain of the person to be examined. Health-related information concerning the mouth/throat/cheek area, i.e., the area of the oral cavity, in particular the teeth, the gingiva and the tongue is omitted here: with the use of cartographic features in the area of the mount/throat/cheeks, in particular disease-related features, symptoms are not determined directly, but instead indirect information is acquired. The features in the mouth/throat/cheek area can permit conclusions about organs and/or circulations at a location different than that the location of the detected features.

Features in the mouth/throat/cheek area are especially suitable in machine acquisition of data such as that provided here:
1. Experience by the inventors has shown that these features allow very accurate conclusions to be drawn quickly about the person's disease and health status. These features are suitable in particular for detecting disturbances in the metabolism, for example, infections of the gastrointestinal tract and for detecting malfunctions of internal organs.
2. According to the experience of the inventors, these features may appear very rapidly, i.e., usually within a few hours and in some cases (for example, in the case of food intolerances) they appear even within a few minutes when there is a health problem or such a problem is indicated or even just hinted at.
3. They disappear equally rapidly when the health problem has been eliminated.
4. They are also easy to detect. Even a layman can discern, qualify and quantify them with the help of simple instructions.
5. They can be detected even by a layman using simple means without necessitating any intervention or special examination instruments. Simply inspecting a patient's mouth using a mirror while the patient's mouth is open or touching the walls of the oral cavity with the tongue and/or a finger is fully sufficient to reliably detect all features.
6. Cartographic information can readily be assigned to these features. This includes information about the existence and location of these features in the area of the oral cavity, in other words, position coordinates and optionally orientation in the terrain or surface relief in the area of the walls of the oral cavity, i.e., on or beneath the surface in a manner that can be detected haptically and/or optically.

The present invention utilizes the advantages of these features technically in at least three ways in any case: firstly, it is based on the high quality of the health-related statements that can be derived from this, so that the method according to the invention makes available reliable output data. Secondly, it is also based on good recognizability, even for a layman, so that the person to be examined can perform the examination himself, and thirdly, it utilizes the means of allocating cartographic properties to features in order to operate in a reference system which can be used in further processing of the machine-readable data thereby made available. This method is thus very reliable and effective and leads to reproducible results with a very good reference basis.

The invention also comprises a method for compiling a number of treatment proposals for treatment of internal organs and/or unusual metabolic features based on health-related information about internal organs and/or the metabolism of a person to be examined, that information having been acquired with a method according to the invention for acquisition of health-related information, such that the possible treatment proposals are derived from the health-related information using rules stored in a database.

In other words, the method according to the invention for acquisition of health-related information is refined by the fact that a number of possible treatment proposals for the person to be examined are derived directly or indirectly from the cartographic features. In doing so, this method makes use of the rules stored in the database.

A data acquisition machine of the type mentioned in the introduction has a data-supplying unit according to the invention, which is designed so that during operation, it acquires cartographic features in the mouth/throat/cheek area of the person to be examined and supplies this information for a subsequent conversion into health-related information about the internal organs or the metabolism in the form of machine-readable data.

In the method according to the invention for acquisition of health-related information, the cartographic features are acquired via an interface with the data acquisition machine. This interface may be designed as part of the data acquisition machine, but it may also be positioned at a great distance from it, for example, in the form of a scanner and/or a fax machine into which paper having the cartographic feature information is input and which then transmits this information to the data acquisition machine. In this case, the data acquisition machine preferably also has an input interface which is not designed as a user interface but rather as a data input interface.

Such interfaces need not necessarily be designed as hardware components but instead may also be implemented entirely or partially as software modules, e.g., in the latter case of a data input interface in which the cartographic feature information can be taken over partially or entirely by a different device which functions as a user interface. The interfaces may also consist of hardware and software components, for example, a standard hardware interface, which is configured specifically by software for a specific use case. Furthermore, several existing interfaces may also be combined in one common interface, for example, an input/output interface.

On the whole, most of the components for implementation of the data acquisition machine in the manner according to the invention, in particular the data supply unit, may be implemented entirely or partially in the form of software modules on a processor.

The present invention therefore also relates to a computer program product, which can be loaded directly into a processor of a programmable system for acquisition of health-related information, having program code means for executing all the steps of a method according to the invention for acquisition of health-related information or a method according to the invention for compiling a number of treatment proposals when the program product is executed on the system.

Furthermore, the invention relates to a system for recording health-related information about internal organs and/or the metabolism of a person to be examined.

This comprises at least:
a question-supplying unit for supplying input questions,
an interface to an acquisition machine according to the invention and
the acquisition machine itself according to the invention.

The method according to the invention for recording health-related information can be performed by using this system.

According to the method for creating a number of treatment proposals, the invention also comprises a system having a similar design for creating a number of treatment proposals for treating internal organs and/or for unusual metabolic conditions based on health-related information about internal organs and/or the metabolism of the person to be examined. This comprises at least:
an acquisition machine according to the invention,
a connection to a database, in which rules are stored,
a treatment proposal deriving unit, which, during operation, derives possible treatment proposals from the health-related information using the rules saved in the database, and
preferably an output interface over which treatment proposals may be output.

Additional particularly advantageous embodiments and refinements of the invention are also derived from the dependent claims as well as the following description. The acquisition machine may also be improved upon in accordance with the dependent claims regarding the similar method.

A special advantage is obtained in the context of the method according to the invention when it also comprises a conversion of the machine-readable data of the cartographic features into health-related information about internal organs and/or the metabolism. This advantage consists of the fact that conclusions which facilitate a diagnosis by a physician, for example, may be drawn from the features ascertained in the area of the oral cavity. Such an additional method step is preferably performed automatically, i.e., independently and purely in a machine-based manner. Additional input data may be used, for example, information about the person to be examined with regard to pain or other symptoms and/or—in a positive sense—about freedom from symptoms, in particular with respect to internal organs and/or metabolic processes. In this case, the cartographic feature information from the area of the oral cavity provides information that is complimentary to the information about which a medical professional usually inquires in order to obtain an overall picture of the person to be examined. Such a conversion of the machine-readable data into health-related information is especially preferably performed on the basis of rules of an expert system stored in a database. An abundance of systematically acquired reference data and findings may be used to draw the correct conclusions from the aforementioned cartographic feature information and the additional input data.

Then in another step, as mentioned above, a number of possible treatment proposals may be derived for the person to be examined from the health-related information obtained by this conversion (and as part of the same, dosage proposals as well as continuous adjustments in the course of such treatment proposals). This procedure constitutes an especially advantageous embodiment of the method according to the invention for compiling a number of treatment proposals because in an intermediate step it incorporates findings which represent a type of interim analysis of the cartographic features. The person to be examined may thus obtain information about his or her own (overall) health condition as well as information for correcting any problems. Within the scope of the present invention, preferably both the health-related information obtained through the conversion and the possible treatment proposals are output to a handler for analysis but are not output to the person to be examined himself. The handler can derive an expert diagnosis from the health-related information and can derive a treatment concept from the treatment proposals. In addition to the information and proposals automatically generated here, the handler may also have access to additional information about the person to be examined, for example, based on his own examinations, which he might wish to include in the overall picture. Such information may also comprise laboratory values which may also be included as input data in the automatic conversion, for example.

On the whole, it should be noted that, for the acquisition of health-related information, the method according to the invention and the acquisition machine according to the invention can additionally process an abundance of different input data and can work on the basis of sophisticated rules from databases. Nevertheless the result of the method according to the invention does not constitute a diagnosis or treatment. This absolutely requires medical expertise. Therefore these results are at most to be understood as the beginning points for a diagnosis and/or proposals for treatment, i.e., as precursors to the actual medical activity.

Additional special advantages are derived when the method according to the invention for acquisition of health-related information is performed multiple times, wherein diagnostic and/or treatment steps are performed preferably by a handler, between the performances of the method. The method then serves to acquire a physical development which has been found to be the result of the therapeutic steps—on the basis of a corresponding comparison logic. As mentioned previously, the features in the area of the oral cavity change very rapidly when a certain organ undergoes a healing process or a disease process. Such a process can thus also be detected and documented especially well with the help of the method according to the invention.

Among other things, the cartographic features are preferably compared with cartographic reference features within the context of a method according to the invention, which is performed repeatedly, and then a relative conclusion and/or a conclusion about the course of the condition is/are drawn. A relative conclusion thus includes providing reference data from which differences in the cartographic features from and/or commonalities with the reference features, respectively, are derived. In this context, features from historical implementations of the method according to the invention for recording health-related information, i.e., previous implementations, may serve as reference features; furthermore, reference features stored elsewhere in a database, for example, typical ideal features originating from scientific experimental series and representing certain disease conditions may also serve as reference features. In the case when considering features from historical implementations, the conclusion about the course, including a statement about the difference between the cartographic reference features of the previous implementation of the method and the cartographic features of the current implementation of the method, can be derived.

As mentioned above, the examination of the mouth/throat/cheek area can also be performed by a layman with no problem. Within the scope of the invention, it is even preferable for a layman to perform the input of the cartographic features via the interface, namely either the person to be examined will himself enter the data or a person assisting the latter will do so, but little or no technical medical knowledge is required. This has the advantage that the expert handler need not see the data and information until the person actually affected has already supplied impartial data. Since this data can in turn be entered by a layman with no problem, adequate intersubjectivity in ascertaining the features is ensured and the handler can in turn work with the information, also in an impartial manner.

Against this background, it has proven to be especially advantageous if the acquisition of data is performed via an interface which is in a separate location from the acquisition machine, i.e., is situated at least in a neighboring room. Even a greater distance from the interface to the acquisition machine, for example, setting up these two elements in different buildings does not constitute a problem here. An especially preferred separation of the two elements is achieved by the fact that the interface and the acquisition machine are connected via a data network, for example, the Internet. Adequate data security is ultimately the only important factor in the transmission. Such a complete separation has the advantage for the person to be examined that said person can perform the data entry at home or at the workplace and need not go separately to a different location to do so. At the same time, this shows especially well the strengths of the present invention because in contrast with other systems, there are no such strict limits on remote inquiry due to the simple possibility of acquisition and the possibility of a precise allocation of features to conditions, for example, symptoms involving certain internal organs and/or metabolic processes.

The cartographic features may be acquired in various forms, for example, as simple information about the presence, type and coordinates of a feature, for example, in the form of a list matrix. However, on account of its practicability and straightforwardness, it has proven advantageous to perform the acquisition of the features in the mouth/throat/cheek area on the basis of a schematized cartographic representation of a typical ideal mouth/throat/cheek area. This typical ideal or schematic representation provides an orientation for the person acquiring the data on the features. At the same time, the acquisition machine can utilize this information as a type of film or scheme for automated further processing and optional conversion into machine-readable, i.e., standardized data, namely specifically when the information is being entered into the cartographic representation.

According to a first variant, such input or listing in the cartographic representation may be performed so that the features are entered into a cartographic representation on paper or a similar physical carrier medium. The cartographic representation completed in this way may then be fed electronically into the acquisition machine, e.g., by scanning.

A second variant, which may be used in addition to or instead of the first variant, consists of the fact that the features are input directly via an electronic user interface, for example, a touchscreen and/or a computer peripheral device such as a keypad, a computer mouse or the like. Due to such an input, the process step of converting the cartographic representation submitted on paper into machine-readable data is eliminated in comparison with the first variant.

The features are especially preferably entered into the cartographic representation in the form of graphic symbol elements. These symbols may be, for example, the known keyboard symbols such as crosses, + signs and circles, their meaning is preferably explained by a legend in conjunction with the cartographic representation. This procedure is also intuitive for a layman. The shape and optionally also the coloration of the graphic symbol elements are also preferably based on the respective feature to be characterized. For example, a recess may be coded using a circle, for example, while an elevation is marked with a cross in accordance with the marking of the highest points on maps.

The features are especially preferably entered into the cartographic representation at a location corresponding at least approximately to a location in the mouth/throat/cheek area of the person to be examined. The input into the cartographic representation also reflects the actual spatial arrangement of the features.

Essentially all types of features in the mouth/throat/cheek area—even below the surface of the skin—may be identified as features, which should also include anything unusual. For example, the statement that a certain area in the mouth/throat/cheek area is completely smooth, unreddened and is also unremarkable otherwise may provide information about the condition of an internal organ and/or a metabolic process. As a result of this method, especially relevant conclusions can be drawn, in particular when the input questions about the features in the mouth/throat/cheek area include such questions relating to features of the skin and/or mucous membranes of the person to be examined in the area of the internal cheeks and/or the lips and/or the palate and/or the gingiva and/or the throat. These features are also easily recognized and identified on the one hand while also being especially specific for certain conditions, for example, symptoms involving certain organs.

Special attention is therefore preferably devoted to the following categories of features:
essentially spot elevations,
essentially spot recesses,
bloody recesses,
essentially longitudinal elevations,
essentially longitudinal recesses,
grooves,
nodules,
injuries,
irregularities of another type,
local variations in color, for example, redness or lower color intensities or white pots or small areas, optionally in combination with recesses.

Again, what was said above also applies, namely that these features are particularly specific on the one hand while on the other hand they are especially easily recognizable by a layman. The input questions therefore relate to at least one of the features mentioned above.

The system according to the invention for compiling a number of treatment proposals and/or the expert system is especially preferably further refined as a self-learning system. This means that the findings from conversions of the cartographic features into health-related information and/or the derived treatment proposals are compiled and fed into the expert system that is used, for example, in the form of statistical acquisition data. Therefore, the reliability in acquisition by the expert system can be increased over a period of time and/or new conditions occurring temporarily but frequently or over the long term can be recognized and optionally also fed into the system.

The present invention will be explained in greater detail again below on the basis of exemplary embodiments with reference to the accompanying figures, where the same components are provided with identical reference notation in the various figures, in which:

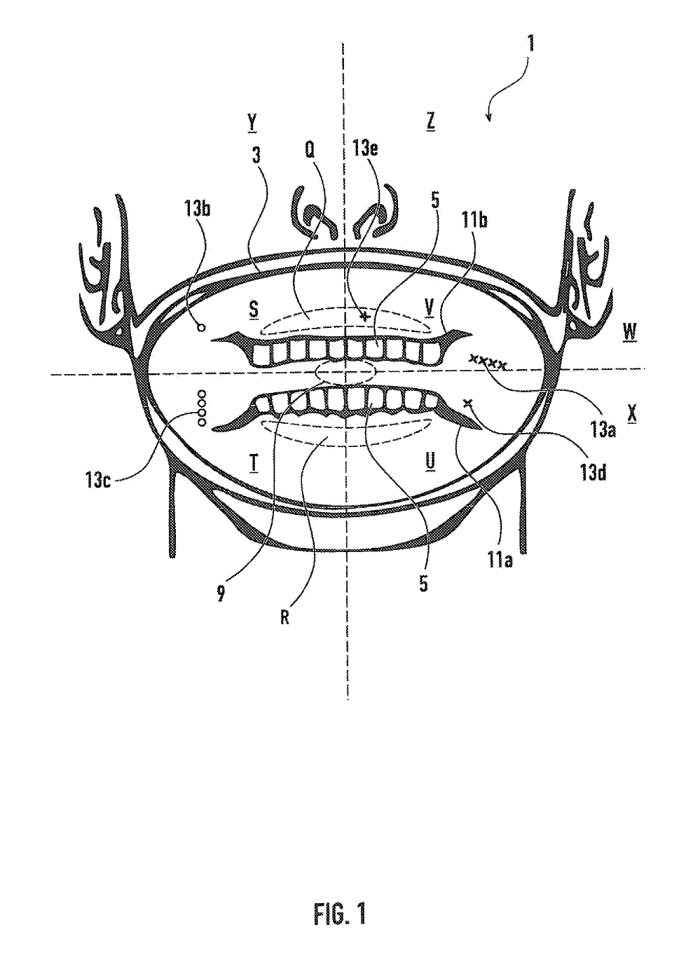

FIG. 1 shows a schematic typical ideal cartographic representation of the mouth/throat/cheek area, such as that which can be used as the basis for performing the method according to the invention,

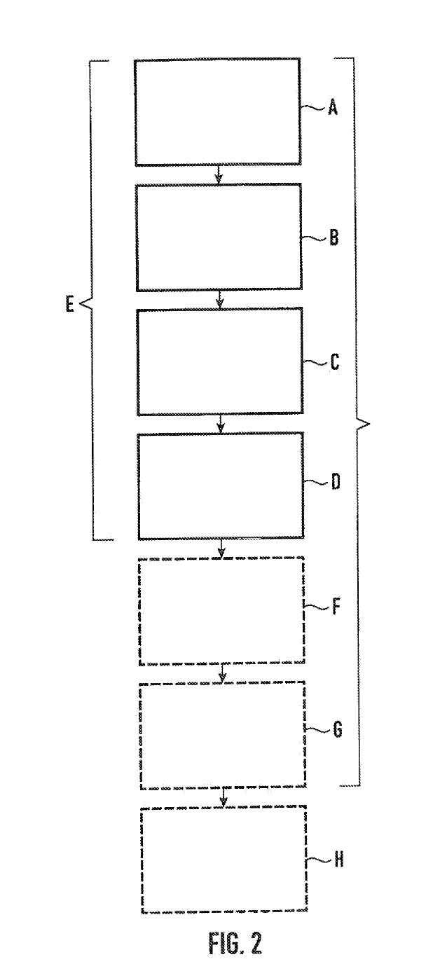

FIG. 2 shows a schematic block diagram of an exemplary embodiment of the method according to the invention for compiling a number of treatment proposals,

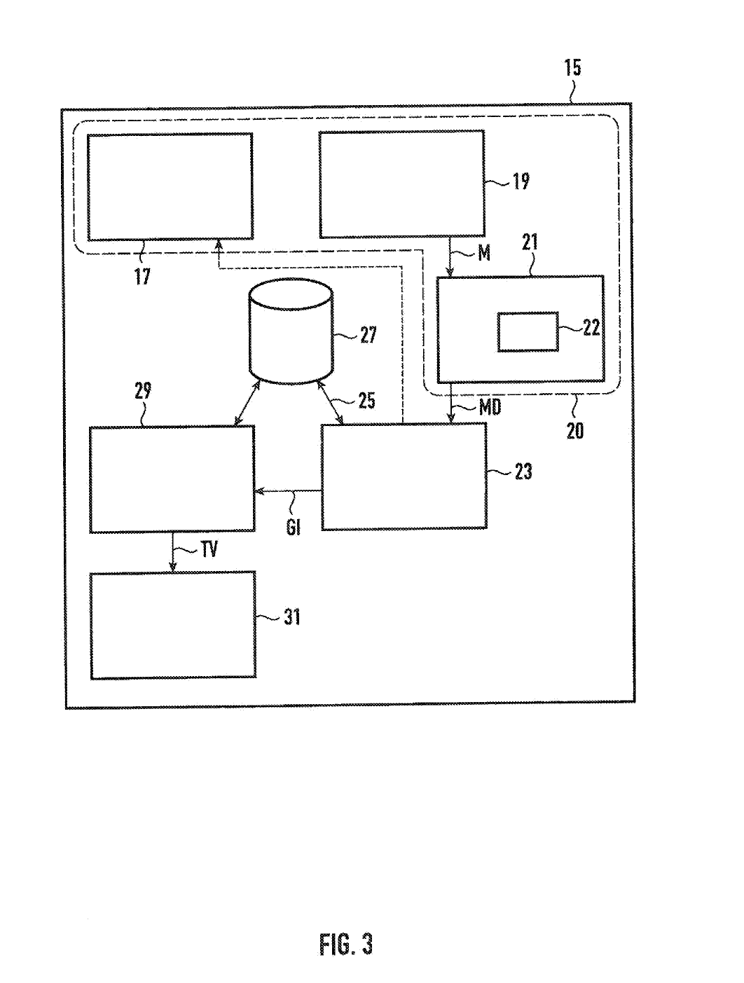

FIG. 3 shows a schematic block diagram of an exemplary embodiment of the system according to the invention for compiling a number of treatment proposals.

FIG. 1 shows a schematic typical ideal cartographic representation of a face 1 with a mouth/throat/cheek area 3, i.e., an oral cavity of a person. This is subdivided in principle into the left half of the face Y and the right half of the face Z (as seen from the standpoint of the person to be examined) as well as the area of the upper oral cavity W and the area of the lower oral cavity X.

A finer subdivision into regions would include accordingly a subdivision into the upper left oral cavity S, the upper right oral cavity V, the lower left oral cavity T, the lower right oral cavity U and situated in the central posterior area, the throat area 9, and the upper lip area Q, the lower lip area R, the upper gingiva 11b and the lower gingiva 11a as well as the teeth 5.

Such a cartographic diagram 1, which may be kept in paper form or may be displayed on a graphical user interface of an input interface, is used for entering the cartographic features 13a, 13b, 13c, 13d, 13e, which are determined by self-examination by the person who is to be examined. The position and orientation of these features 13a, 13b, 13c, 13d, 13e are predetermined by means of graphical symbol elements, which are explained in a legend (not shown), entered into the cartographic diagram 1 there, where they are located approximately in the oral cavity of this person. Elevations 13a, 13d here are indicated as crosses, recesses 13b, 13c are indicated as circles, and a bloody recess 13e is indicated with a + symbol. The first elevation 13a is a longitudinal elevation, which is therefore entered in the form of multiple crosses, and in an approximately horizontal alignment in the area of the upper right portion of the oral cavity V. The first recess 13b is in the form of spots and is localized in the area of the upper left portion of the oral cavity S. The second recess 13c is again longitudinal and therefore has multiple circles in a vertical orientation in the area of the lower left portion of the oral cavity T. The second recess 13d in the lower right portion of the oral cavity U is point-like. There is a bloody recess 13e in the upper lip area Q.

Based on these entries and the cartographic diagram 1, the machine-readable data may be supplied in the form of a hexadecimal code with the help of the method according to the invention, which then permits a derivation of health-related information about the condition of the internal organs and/or the metabolism of the person to be examined, for example, about the condition of the digestive tract and/or the spleen of the person to be examined.

FIG. 2 shows schematically the sequence of an exemplary embodiment of a method I according to the invention for compiling a number of treatment proposals, including an exemplary embodiment of a method E for recording health-related information.

In a first step A, input questions are supplied, relating at least to cartographic features in the mouth/throat/cheek area, among other things. The answers to these questions are entered via an interface in a step B, and then in a step C, they are acquired in an acquisition machine, which supplies machine-readable data on the basis of these features in a step D. Steps A through D are thus the essential steps of method E according to the invention for acquisition of health-related information which can be further expanded by a conversion of the cartographic features and to health-related information about the internal organs and/or the metabolism in a step F and optionally further in a step G, a number of possible treatment proposals for the person to be examined may be generated from the health-related information obtained by this conversion. At least this step G is essential for performing the method I according to the invention for generating a number of treatment proposals, but step F may be omitted if necessary. Another optional step H consists of output of the information thereby acquired, i.e., the machine-readable data and/or the health-related information and/or the treatment proposals.

FIG. 3 shows schematically an exemplary embodiment of a system 15 for compiling a number of treatment proposals. It includes a question-supplying unit 17 for supplying input questions, an interface 19 and an acquisition machine 21 permanently or temporarily connected to this interface 19 as well as a conversion unit 23 connected to a database 27 of an expert system via a link 25, a treatment proposal deriving unit 29 and an output interface 31. The acquisition machine 21 comprises a data supplying unit 22.

Cartographic features M from the mouth/throat/cheek area of a person to be examined, for example, the type as described in conjunction with FIG. 1, are fed into the acquisition machine 21 via the interface 19. This acquisition machine acquires the cartographic features M and their data-supplying unit makes them available in the form of machine-readable data MD. In the conversion unit 23, the machine-readable data MD are converted into health-related information GI about the internal organs and/or the metabolism of the person to be examined from whom the cartographic features M have been obtained in comparison with rules stored in the database 27. Subsequently signals to the question-supplying unit 17 may be derived from the health-related information GI, namely signals pertaining to which additional questions are optionally still to be examined. The treatment proposal deriving unit 29 derives treatment proposals TV from the health-related information GI in comparison with the same database 27, optionally also with another database (not shown), and these treatment proposals are output via the output interface 31 to a handler who is subsequently concerned with possible treatments and/or diagnoses for the person thereby examined.

The question-supplying unit 17, the interface 19 and the acquisition machine 21 together form a system 20 for acquisition of health-related information with which all the steps of the similar method E according to the invention can be performed as described in conjunction with FIG. 2.

In conclusion, one possible concrete process sequence will be illustrated on the basis of one example within the context of the method according to the invention for compiling a number of treatment proposals.

For example, a person to be examined may sense by touch some longitudinal irregularities in the area of the left cheek. These cartographic features can be converted into the health-related information that the person has functional and/or organic disturbances in the area of the liver/gall bladder, for example, stones and/or an outflow obstacle.

By adding additional information with respect to other cartographic features in the mouth/throat/cheek area as well as based on additional questions, this health-related information can be further refined, if necessary. The expert system derives from this, for example, as one possible treatment proposal that the patient should take medication and/or active ingredients to stimulate outflow out of the gall bladder and/or to change the composition of the secretions by the liver and/or gallbladder.

In conclusion, it should be pointed out again that the methods described in detail above as well as the system which is presented here are merely examples that those skilled in the art are capable of modifying in a wide variety of ways without going beyond the scope of the invention.

In particular, individual details of the system may also be combined, for example, as software modules on a processor. They may also be separated from one another in space and may be connected to one another via a network, such as the Internet, for example. In addition, the use of the indefinite article “a/an” and/or “one” does not rule out the possibility that the respective features may also be present in multiple instances.

### LIST OF REFERENCE NUMERALS

1 cartographic representation
3 mouth/throat/cheek area—oral cavity
5 teeth
9 throat area
11a lower gingiva
11b upper gingiva
13a longitudinal elevation—cartographic feature
13b spot recess—cartographic feature
13c longitudinal recess—cartographic feature
13d point-like recess—cartographic feature
13e bloody recess—cartographic feature
15 system for compiling a number of treatment proposals
17 question-supplying unit 17
19 interface
20 system for recording health-related information
21 acquisition machine
22 data-supplying unit
23 conversion unit
25 link
27 database
29 treatment-proposal-deriving unit
31 output interface
A method step—supplying input questions
B method step—input of answers
C method step—acquisition
D method step—supplying machine-readable data
E method for recording health-related information
F method step—conversion of the cartographic features
G method step—generating possible treatment proposals
GI health-related information
H method step—output
I method for compiling a number of treatment proposals
M cartographic features
MD machine-readable data
Q upper lip area
R lower lip area
S upper left portion of oral cavity
T lower left portion of oral cavity
TV treatment proposals
U lower right portion of oral cavity
V upper right portion of oral cavity
W upper oral cavity
X lower oral cavity
Y left half of face
Z right half of face

1. A method (E) for recording health-related information (GI) about internal organs and/or the metabolism of a person who is to be examined, wherein cartographic features (M, 13a, 13b, 13c, 13d, 13e) in the mouth/throat/cheek area (3) of the person to be examined are compiled on the basis of input questions via an interface (19) with an acquisition machine (21) and are made available in the form of machine-readable data (MD) for subsequent conversion into health-related information (GI) about the internal organs and/or the metabolism.

2. The method according to claim 1, additionally comprising a conversion of machine-readable data of the cartographic features (M, 13a, 13b, 13c, 13d, 13e) into health-related information (GI) about the internal organs and/or the metabolism.

3. The method according to claim 2, wherein the conversion is performed on the basis of rules of an expert system stored in a database (27).

4. The method according to any one of claim 2 or 3, wherein a number of possible treatment proposals (TV) for the person to be examined are derived from the health-related information (GI) obtained as a result of the conversion.

5. The method according to any one of the preceding claims, wherein the cartographic features (M, 13a, 13b, 13c, 13d, 13e) are compared with cartographic reference features and a relative statement and/or a conclusion about the course are derived from this.

6. The method according to any one of the preceding claims, wherein the data is acquired via an interface (19) which is spatially separate from the acquisition machine (21).

7. The method according to any one of the preceding claims, wherein the features (M, 13a, 13b, 13c, 13d, 13e) in the mouth/throat/cheek area are acquired on the basis of a schematic cartographic representation (1) of a typical ideal mouth/throat/cheek area.

8. The method according to claim 7, characterized in that the features (M, 13a, 13b, 13c, 13d, 13e) are entered at a location in the cartographic representation (1) corresponding to a location in the mouth/throat/cheek area of the person to be examined.

9. The method according to any one of the preceding claims, wherein the input questions about the features (M, 13a, 13b, 13c, 13d, 13e) in the mouth/throat/cheek area include questions which relate to aspects of the skin and/or mucous membranes of the person to be examined in the area of the inner cheeks and/or the lips (Q, R) and/or the palate and/or the gingiva (11a, 11b) and/or the throat (9).

10. The method according to any one of the preceding claims, wherein the input questions relate to at least one of the following features:
essentially point-like elevations (13d),
essentially point-like recesses (13b),
bloody recesses (13e),
essentially longitudinal elevations (13a),
essentially longitudinal recesses (13c),
grooves,
nodules,
injuries,
irregularities of another type,
local variations in color.

11. The method (I) for compiling a number of treatment proposals (TV) for treatment of internal organs and/or metabolic irregularities based on health-related information (GI) about internal organs and/or about the metabolism of a person to be examined, said information (GI) having been acquired by a method (E) according to any one of claims 1 to 12, wherein the possible treatment proposals (TV) are derived from the health-related information (GI) using rules saved in a database (27).

12. An acquisition machine (21) for recording health-related information (GI) about internal organs and/or the metabolism of a person to be examined, having a data-supplying unit (22) which is designed so that, during operation, it acquires cartographic features (M, 13a, 13b, 13c, 13d, 13e) in the mouth/throat/cheek area of the person to be examined and supplies this data for a subsequent conversion to health-related information (GI) about the internal organs and/or the metabolism in the form of machine-readable data (MD).

13. A system (20) for recording health-related information (GI) about internal organs and/or the metabolism of a person to be examined, comprising at least:
a question-supplying unit (17) for supplying input questions,
an interface (19) with an acquisition machine (21) according to claim 12 for acquisition of cartographic features (M, 13a, 13b, 13c, 13d, 13e) in the mouth/throat/cheek area of the person to be examined,
the acquisition machine (21) according to claim 12.

14. The system (15) for compiling a number of treatment proposals (TV) for treatment of internal organs and/or of metabolic aspects on the basis of health-related information (GI) about internal organs and/or the metabolism of the person to be examined, comprising at least:
an acquisition machine (21) according to claim 12,
a link (25) to a database (27) in which rules have been stored,
a treatment-proposal-deriving unit (29) which derives possible treatment proposals (TV) from the health-related information (GI) using the rules stored in the database (27).

15. A computer program product which can be loaded directly into the processor of a programmable system (20) for acquisition of health-related information, having program code means for executing all the steps of a method according to any one of claims 1 to 10 and/or a method according to claim 11 when the program product is executed on this system.
